(19) United States
(12) Patent Application Publication
(10) Pub. No.: US 2016/0300563 A1
(43) Pub. Date: Oct. 13, 2016

(54) ACTIVE NOISE CANCELLATION FEATURING SECONDARY PATH ESTIMATION

(71) Applicant: QUALCOMM Incorporated, San Diego, CA (US)

(72) Inventor: Hyun Jin Park, San Diego, CA (US)

(73) Assignee: QUALCOMM Incorporated, San Diego, CA (US)

(21) Appl. No.: 14/684,962

(22) Filed: Apr. 13, 2015

(51) Int. Cl. G10K 11/175

(52) U.S. Cl. CPC G10K 11/175

(57) ABSTRACT

Techniques for robust estimation of a secondary path transfer function in an active noise cancellation (ANC) system are disclosed. The estimation techniques do not rely on a pilot signal. In addition, the techniques provide good approximations of secondary path transfer functions, and further, they can greatly reduce the risk of instability in feedback ANC systems. In one aspect, a secondary path transfer function estimation method includes receiving a first environmental signal (e.g., a reference microphone signal) and a second environmental signal (e.g., an error microphone signal) at an ANC system. The secondary path transfer function is then estimated based on the first environmental signal and the second environmental signal.

### TECHNICAL FIELD

This disclosure generally relates to audio signal processing, and in particular, to active noise cancellation or active noise control (ANC) systems and methods.

### BACKGROUND

Active noise cancellation (ANC, also called active noise reduction or active noise control) is a technology that actively reduces acoustic noise by generating a waveform that is an inverse form of the noise wave (e.g., having the same level and an inverted phase), also called an “antiphase” or “anti-noise” waveform. An ANC system generally uses one or more microphones to pick up an external noise reference signal, generates an anti-noise waveform based on the noise reference signal, and reproduces the anti-noise waveform through one or more loudspeakers. This anti-noise waveform interferes destructively with the original noise wave to reduce the level of the noise that reaches the ear of a listener.

Some electronic devices, for example, portable communication devices such as cellular phones, smartphones, headphones, earphones, music players, laptop computers, and the like, may be used in noisy environments. Active noise cancellation techniques may be applied to such devices to reduce acoustic noise from the surrounding environment. In such applications, the use of an ANC technique may reduce the level of background noise that reaches a user's ear while delivering useful sound signals, such as music and far-end voice.

The acoustic environment of portable devices may change in real-time. As a result, the use of adaptive ANC systems has been proposed to help improve the user's listening experience in surroundings where the ambient noise level or the particular positioning or use of the device varies. An adaptive ANC system relies on models of different electro-acoustic paths in the surrounding environment leading to a desired quiet area, e.g., the listener's ear canal. For instance, some adaptive ANC systems use models of a feedback path, a primary path and a secondary path. Using such models along with microphones that detect the acoustic background noise, an adaptive ANC system can continuously adapt the state of its adaptive filtering in real-time so as to produce an anti-noise signal that better cancels the undesired ambient noise.

### SUMMARY

In adaptive feed-forward (FF), feedback (FB) and hybrid ANC systems, accurately modeling or estimating a transfer function representing an electro-acoustic secondary path is desirable. The secondary path is an electro-acoustic path between the anti-noise loudspeaker input and error microphone output signal. The nature of the secondary path is determined by operational characteristics of loudspeaker and the acoustic channel between loudspeaker and the error microphone.

A known approach of estimating a secondary path (Sₚₐₜₕ) transfer function is to measure the Sₚₐₜₕ response of an ANC system offline and use the offline Sₚₐₜₕ estimate during online operation of the ANC filters. The term “offline” may refer to operational state of the ANC system and mean that the ANC system is not operating to cancel noise. The term “online” may mean that the ANC system is presently operating to cancel noise. This method of offline estimation of the Sₚₐₜₕ works if the Sₚₐₜₕ does not change online (during noise cancellation operation), and is thus effective only in special cases.

Another known method of estimating an Sₚₐₜₕ transfer function is to perform the estimation online (while noise cancellation is performed), using a pilot signal. In this approach, an internally generated pilot signal (e.g., random noise, sine tone, received audio signals, or the like) is mixed into an anti-noise loudspeaker input signal. Using the pilot signal as reference and an error microphone signal, the ANC system can execute online an approximation method, e.g., least mean squares (LMS) approximation, Recursive least square (RLS) approximation, Wiener filter, or the like. This approach may work with some accuracy, but the pilot tone is an unwanted artifact that may be heard by a listener, such that it is sometimes undesirable to use in practical end-user devices.

There are ANC-enabled devices where Sₚₐₜₕ changes online, and thus, online estimation of the Sₚₐₜₕ transfer function without using a pilot signal is desirable to improve the performance of adaptive ANC. These ANC-enabled devices may include portable communication devices, for example, headphones, earphones, cellular handsets, smart phones and the like.

To address these needs, disclosed herein are techniques for robust online estimation of an Sₚₐₜₕ transfer function in an ANC system. The inventive techniques do not rely on a pilot signal. In addition, the techniques may provide good approximations of Sₚₐₜₕ transfer functions at low computational costs, and further, they can greatly reduce the risk of instability in FB ANC systems.

In accordance with an aspect of the disclosed techniques, a method of estimation includes receiving a first environmental signal (e.g., a reference microphone signal) at an active noise cancellation (ANC) system and receiving a second environmental signal (e.g., an error microphone signal) at the ANC system. The ANC system then estimates a secondary path transfer function based on the first environmental signal and the second environmental signal.

In accordance with another aspect, an ANC system includes a first input configured to receive a first environmental signal, a second input configured to receive a second environmental signal, and a processor configured to estimate a secondary path transfer function based on the first environmental signal and the second environmental signal.

According to a further aspect, a system includes means for receiving a first environmental signal, means for receiving a second environmental signal, and means for estimating a secondary path transfer function of an ANC system based on the first environmental signal and the second environmental signal.

According to a further aspect, a computer-readable medium embodying a set of instructions executable by one or more processors stores code for receiving a first environmental signal, code for receiving a second environmental signal, and code for estimating a secondary path transfer function of an ANC system based on the first environmental signal and the second environmental signal.

Other aspects, features, and advantages will be or will become apparent to one with skill in the art upon examination of the following figures and detailed description. It is intended that all such additional features, aspects, and advantages be included within this description and be protected by the accompanying claims.

### BRIEF DESCRIPTION OF THE DRAWINGS

It is to be understood that the drawings are solely for purpose of illustration and do not define the limits of the appended claims. Furthermore, the components in the figures are not necessarily to scale. In the figures, like reference numerals designate corresponding parts throughout the different views.

FIG. 1 is a conceptual block diagram illustrating certain components of an exemplary acoustic environment employing an active noise cancellation (ANC) system.

FIG. 2 is a control block diagram illustrating transfer functions representing the audio environment and ANC system of FIG. 1.

FIG. 3 is a control block diagram illustrating an alternative set of transfer functions representing the audio environment and ANC system of FIG. 1.

FIG. 4 is a flowchart illustrating an exemplary method operating the ANC system of FIG. 1.

FIG. 5 is a conceptual block diagram illustrating certain components of a feedback ANC system that estimates a secondary path transfer function based on error microphone and reference microphone signals.

FIG. 6 is a conceptual block diagram illustrating certain components of a hybrid ANC system that estimates the secondary path transfer function based on error microphone and reference microphone signals.

FIG. 7 is a conceptual block diagram showing an exemplary portable communication device that includes an ANC system such as one of those described herein.

FIG. 8 is a conceptual block diagram showing an exemplary headphone that includes an ANC system such as one of those described herein.

FIG. 9 is a conceptual block diagram illustrating certain components of an exemplary electronic device that may implement one or more of the ANC systems disclosed herein.

FIG. 10 is a conceptual block diagram illustrating certain components of an exemplary wireless communication device that may implement one or more of the ANC systems disclosed herein.

### DETAILED DESCRIPTION

The following detailed description, which references to and incorporates the drawings, describes and illustrates one or more specific embodiments of what is claimed. These embodiments, offered not to limit but only to exemplify and teach what is claimed, are shown and described in sufficient detail to enable those skilled in the art to practice what is defined by the claims. Thus, where appropriate to avoid obscuring the inventive subject matter, the description may omit certain information known to those of skill in the art. The embodiments disclosed herein are examples that should not be read to unduly limit the scope of the claims.

The word “exemplary” is used throughout this disclosure to mean “serving as an example, instance, or illustration.” Any embodiment or feature described herein as “exemplary” is not necessarily to be construed as preferred, commended, or advantageous over other embodiments or features.

The systems, methods and computer program products disclosed herein may be applied to a variety of electronic devices. Examples of electronic devices include cellular phones, smartphones, headphones, earphones, ear buds, video cameras, audio players (e.g., Moving Picture Experts Group-1 (MPEG-1) or MPEG-2 Audio Layer 3 (MP3) players), video players, audio recorders, desktop computers/laptop computers, personal digital assistants (PDAs), gaming systems, and the like. One kind of electronic device is a communication device, which may communicate with another device. Examples of communication devices include telephones, laptop computers, desktop computers, cellular phones, smartphones, e-readers, tablet devices, gaming systems, and the like.

An electronic device or communication device may operate in accordance with certain industry standards, such as International Telecommunication Union (ITU) standards and/or Institute of Electrical and Electronics Engineers (IEEE) standards (e.g., Wireless Fidelity or “Wi-Fi” standards such as 802.11a, 802.11b, 802.11g, 802.11n and/or 802.11ac). Other examples of standards that a communication device may comply with include the Bluetooth standard, IEEE 802.16 (e.g., Worldwide Interoperability for Microwave Access or “WiMAX”), Third Generation Partnership Project (3GPP), 3GPP Long Term Evolution (LTE), Global System for Mobile Telecommunications (GSM) and others (where a communication device may be referred to as a User Equipment (UE), NodeB, evolved NodeB (eNB), mobile device, mobile station, subscriber station, remote station, access terminal, mobile terminal, terminal, user terminal, subscriber unit, etc., for example). While some of the systems and methods disclosed herein may be described in terms of one or more standards, this should not limit the scope of the disclosure, as the systems and methods may be applicable to many systems and/or standards.

It should be noted that some communication devices may communicate wirelessly and/or may communicate using a wired connection or link. For example, some communication devices may communicate with other devices using an Ethernet protocol. The systems, methods and computer program products disclosed herein may be applied to communication devices that communicate wirelessly and/or that communicate using a wired connection or link.

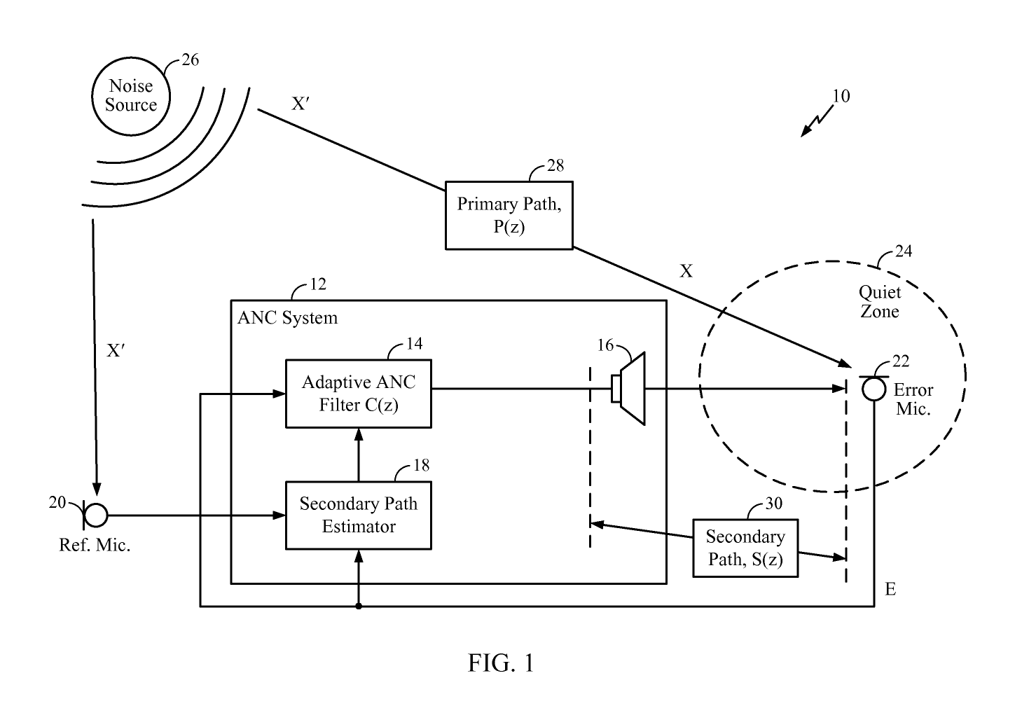

FIG. 1 is a conceptual block diagram illustrating certain components of an exemplary acoustic environment 10 employing an exemplary active noise cancellation (ANC) system 12. The acoustic environment 10 includes a noise source 26, the ANC system 12, which receives signals from a noise reference microphone (MIC) 20 and an error microphone 22. Although shown as separate devices, the microphones 20, 22 may be considered as part of the ANC system 12. The error microphone 22 is located within a quiet zone 24. The quiet zone 24 is an area, e.g., an ear canal, in which noise control or cancellation is desired.

The noise and error microphones 20, 22 may each be a transducer that converts acoustic signals into electrical or electronic signals. For example, the noise microphone 20 may convert environmental acoustic noise signals X′ (e.g., environmental noise, background noise, ambient noise, etc.) into an electrical or electronic noise signal, and the error microphone 22 may convert sound received in the quite zone 24 into an electrical or electronic error signal, E. The sound received in the quiet zone 24 may include the audio output of the anti-noise loudspeaker 16 and the ambient environmental noise, X, actually reaching the quiet area 24.

The ANC system 12 includes an adaptive ANC filter 14, which is modeled by a filter control transfer function, C(z). The ANC system 12 also includes a secondary path estimator 18, and an anti-noise loudspeaker 16 for outputting an anti-noise audio signal into the quiet area 24. The loudspeaker 16 is driven by anti-noise output signals from the adaptive ANC filter 14.

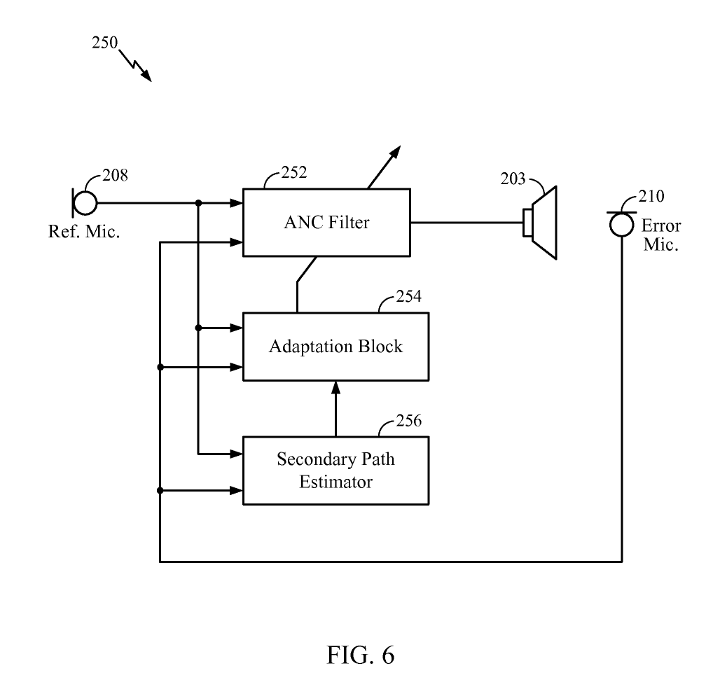

Although, FIG. 1 illustrates a feedback (FB) ANC system including the reference microphone 20, the ANC system 12 may alternatively be a hybrid (combined FB and feed-forward) ANC system (as illustrated in FIG. 6). Generally, adaptive ANC systems may be classified into one of three types of control structures: 1) a feedback ANC system, 2) a feed-forward ANC system, or 3) a hybrid ANC system.

A feedback ANC system may be characterized as using an error microphone signal disposed to sense system output in combination with an anti-noise loudspeaker to achieve the noise control process. In feedback ANC, the system output is fed back to the adaptive ANC filter and the filter is adjusted through an adaptive algorithm to minimize total system output power. In other words, the system output serves as the error signal for the adaptive filtering process. Feedback ANC systems usually have better low frequency performance (<100 Hz) than feed-forward ANC systems, but do not reach the bandwidth of feed-forward systems. Typically, feedback ANC systems may work well to 1 kHz and have a more flat ANC distribution with lower peak values.

A feed-forward ANC system may be characterized as using a reference microphone disposed to sense ambient noise, rather than system output like the error microphone, and an anti-noise loudspeaker to achieve the noise control process. In feed-forward ANC, the reference microphone signal is provided to the adaptive ANC filter and the filter is adjusted through an adaptive algorithm to minimize the noise signal. Advantages of feed-forward ANC systems are that they may have a wider ANC bandwidth than the feedback topology and the ANC filtering is essentially independent of the audio signal path.

Hybrid ANC systems correspond to a combination of control structures from the feedback and feed-forward systems, where the cancelling signal is generated based on the outputs of both the reference microphone and the error microphone. In a hybrid ANC system, a feed-forward subsystem may attenuate the primary noise, which is correlated with the reference microphone signal, a feedback subsystem may cancel the predictable components of the primary noise signal that are not observed by the reference microphone, but instead by the error microphone. The hybrid ANC topology combines the advantages of both feedback and feed-forward ANC systems into a single system. It allows better ANC performance levels and wider ANC bandwidth. One subsystem compensates for the lacks of the other subsystem and vice versa. Hybrid ANC systems typically show better ANC performance from 20 Hz up to 3 kHz, which is not possible with a standalone feed-forward or feedback ANC system.

In some configurations, the speaker 16 may exclusively output the anti-noise signal. In other configurations, the speaker 16 may output the anti-noise signal in addition to one or more other acoustic signals (e.g., music, speech, or the like). For example, the speaker 16 may be an earpiece speaker on a cellular phone or a headset. It is noted that one or more speakers 16 may be used.

A primary path transfer function (e.g., noise transfer function) 28 models the transmission of the noise signal, X′, from the noise source 26 to the quiet area 24. The primary path transfer function 28 may be denoted P(z). The noise signal reaching the quiet area 24 and error microphone 22 is denoted by X.

The secondary path estimator 18 estimates the secondary path 30 (Sₚₐₜₕ) transfer function, S(z). The secondary path transfer function (e.g., speaker transfer function) 30 models the transmission of the anti-noise signal output from adaptive ANC filter 14, transmitted through the speaker 16 to the error microphone 22.

The ANC system 12 uses a novel technique to estimate the Sₚₐₜₕ transfer function 30 online, during noise cancellation operation. This technique estimates the Sₚₐₜₕ transfer function 30 based on the noise signal X′ from the reference microphone 20 and the error microphone signal, E, from the error microphone 22 under FB or hybrid ANC operating conditions. A noise reference microphone signal is typically available in a hybrid ANC system. An extra noise reference microphone may be added to an FB ANC system in order to perform the Sₚₐₜₕ transfer function estimation described herein.

Referring to FIG. 1, the reference microphone 20 captures incoming environmental noise X′. The environmental noise signal, X′, at the error microphone 20 can be related to the noise reaching the quiet area 24, X, as X=P X′. In practical applications, i.e., where there is little or no passive attenuation of the environmental noise along the primary path (e.g., low frequency noise), P is typically close to unity gain with tiny phase delay at low frequencies (ex: 100 Hz). So X can be approximated or readily estimated from X′.

Unlike known Sₚₐₜₕ estimation methods, the disclosed Sₚₐₜₕ estimation methods do not require a pilot signal to be mixed to the anti-noise speaker, and can operate effectively in real environments where there is some audio noise at low frequencies. In the case of very quiet audio environments, where ANC is not needed, the ANC system can be turned off or go to lower gain to mute its effect. Also, the simplified form of the disclosed estimation methods gives good approximation at a very low computation cost. Additionally, the simplified form of the disclosed method is robust since estimating the ratio of |E|/|X| at a low audio frequency is quite robust with FB or Hybrid ANC systems.

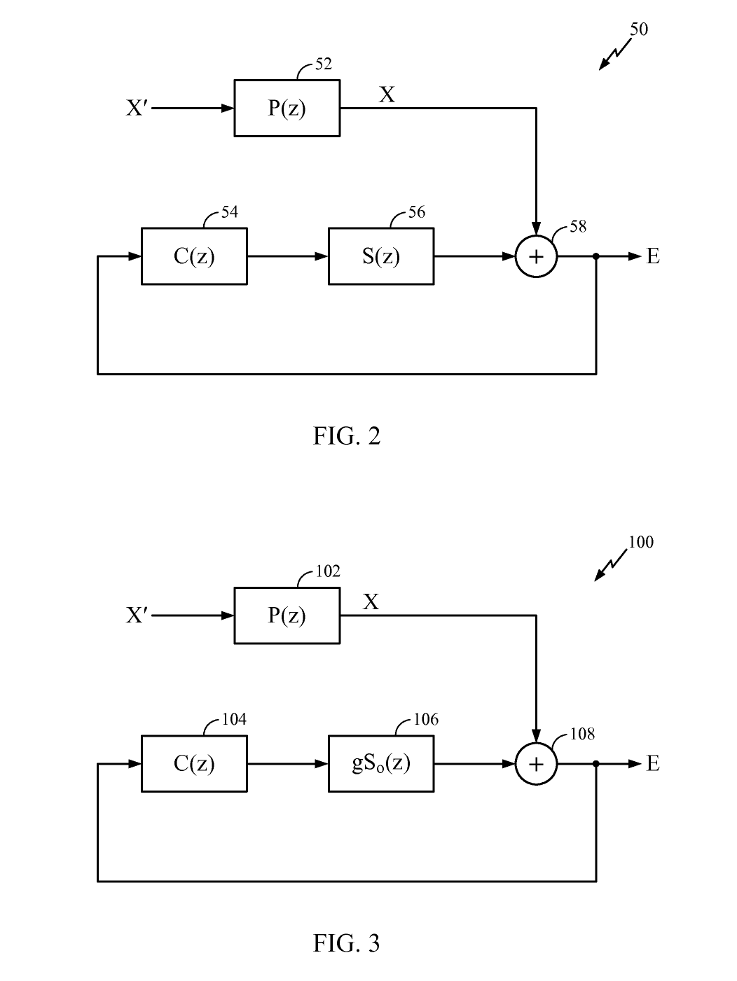

FIG. 2 is a control block diagram 50 depicting transfer functions representing operation of the ANC system 12 in the audio environment 10. The control block diagram 50 depicts the signal processing performed by the ANC system 12 in the discrete time or z-domain. Block 52 depicts the primary path transfer function (e.g., passive attenuation transfer function, which may be unity), P(z), block 54 depicts the adaptive FB ANC filtering transfer function, C(z), block 56 depicts the secondary path transfer function, S(z). A summer 58 depicts the combining of the output of the ANC system 12 and the environmental noise arriving along the primary path in the quiet area 24. The output of the summer 58 depicts the error microphone signal, E.

As depicted in the control block diagram 50, the error microphone signal, E, is related to the attenuated incoming noise signal, X, by the following equations:

E(z)=X(z)+C(z)×S(z)×E(z) (Eq. 1)

E(z)=X(z)/[1−C(z)S(z)] (Eq. 2)

At any given time during operation of the ANC system 12, the FB ANC control filter transfer function, C(z), is known Likewise, the error microphone signal, E(z), may be measured and thus known. As discussed above, in certain practical applications, the attenuated environmental noise signal, X(z), is approximated by or readily estimated from the noise signal, X′(z), measured by the noise microphone 20.

An adaptive identification method, e.g., least mean square (LMS), recursive least square (RLS), Wiener filter, or the like, may be performed to estimate a transfer function A(z), such that E(z)=A(z)X(z). The secondary path estimators 18, 206, 256 disclosed herein may be configured to compute the adaptive identification method.

According to the FB ANC system transfer function above (Eq. 2):

A(z)=1/[1−C(z)S(z)] (Eq. 3)

Thus, from Equation 3, the secondary path transfer function, S(z), may be computed using:

S(z)=(A(z)−1)/A(z)C(z) (Eq. 4)

In some practical applications of FB or hybrid ANC systems including a reference microphone, the Sₚₐₜₕ model can be simplified to derive an even simpler estimation method of the Sₚₐₜₕ. For example, FIG. 3 shows a control block diagram 100 illustrating an alternative, simplified set of transfer functions representing the audio environment 10 of FIG. 1. As described in detail below, a simpler estimation of the secondary path transfer function may be performed by the control block 100.

The control block diagram 100 depicts alternative signal processing performed by the ANC system 12 in the discrete time or z-domain. Block 102 depicts the primary path transfer function (e.g., passive attenuation transfer function, which may be unity), P(z), block 104 depicts the adaptive FB ANC filtering transfer function, C(z), block 106 depicts the secondary path transfer function, S(z), where S(z)=gS₀(z). A summer 108 depicts the combining of the output of the ANC system 12 and the environmental noise arriving along the primary path in the quiet area 24. The output of the summer 108 depicts the error microphone signal, E.

In many portable ANC devices (headsets, earphones, ear buds, handsets, etc. that include ANC systems), Sₚₐₜₕ may change with different users and user-fittings, but the change is usually approximated well by modifying the Sₚₐₜₕ transfer function by a scalar gain factor, g. In these applications, S(z) can be approximated by S(z)=gS₀(z), where S₀(z) is the secondary path transfer function measured offline (also referred to herein as the baseline secondary path transfer function), and g is a variable scalar. This simplification works well in some applications such as with portable communication devices, especially in low frequency audio region below 600 Hz.

Applying the simplification, S(z)=g S₀(z), to Equation 2 above:

E(z)=1/[1−gC(z)S₀(z)]X(z) (Eq. 5)

Equation 5 can be transformed to a specific frequency by substituting Z=e^{(jω)}=e, resulting in:

E(e)/X(e)=1/[1−g C(e)S₀(e)] (Eq. 6)

|E(e)/X(e)|=1/|1−g C(e)S₀(e)|, (Eq. 7)

where |E(e)/X(e)| is a noise reduction transfer function at the specific frequency, e.g., 100 Hz, and C(e) S₀(e) is the combined frequency response of C×S₀ at the specific frequency.

The result C(e)×S₀(e) is a complex number a+bi that shows the magnitude and phase of the combined filter at the specific frequency (e.g., 100 Hz). By replacing R=|E(e)/X(e)|, and C(e) S₀(e)=a+bi, the following exact solution for g is derived as follows.

By replacing R=|E(e)/X(e)|, and C(e) S₀(e)=a+bi in Eq. 7, Eq. 7 becomes:

R=1/|1−g(a+bi)| (Eq. 8)

Rearranging Eq. 8 yields:

|1−g(a+bi)|=1/R (Eq. 9)

|1−g(a+bi)|²=1/R² (Eq. 10)

(1−ga−gbi)×(1−ga+gbi)=1/R² (Eq. 11)

(1−ga)²+(gb)²⁼1/R² (Eq. 12)

1+g²×(a²b²)−2ga=1/R² (Eq. 13)

g²×(a²b²)−2ag+(1−1/R²)=0 (Eq. 14)

Eq. 14 is a quadratic equation of the form sg²+tg+u=0, where

s=a²+b² (Eq. 15)

t=2a (Eq. 16)

u=1−1/R² (Eq. 17)

Applying the quadratic formula to Eq. 14 to solve for the scalar gain, g, yields the exact solution:

g=[a±sqrt (a²−4(a²+b²)(1−1/R²))]/2(a²+b²) (Eq. 18)

In certain ANC applications, the scalar gain g can be approximated based on Eq. 12, instead of using the exact solution given by Eq. 18. In some ANC applications, b is close to zero and thus in some circumstances b can be ignored from above Eq. 12. In these cases, b is close to zero because a+bi=A exp(iθ)=A (cos (θ)+i sin(θ)), where θ is the phase delay and is close to zero. The phase delay θ is typically close to zero at low frequencies of the transfer function C(e)S₀(e). This is simply because the phase delay of CxS is quite short (<20 mm) comparison to the audio wavelength around 100 Hz (which is about 3400 mm).

For example, in an audio environment at 100 Hz, the magnitude of this combined response is typically a number ranging from 1 to 10, and the phase delay is between −10 and +10 degrees. This results in b<<a. In such cases, the scalar gain, g, can be approximated by ignoring b (letting b=0) in Eq. 12, resulting in:

(1−ga)²=1/R² (Eq. 19)

Solving Eq. 19 for g yields:

(1−ga)=±1/R (Eq. 20)

g=(1±1/R)/a (Eq. 21)

The case where g=(1+1/R)/a can be ignored because R=|E|/|X| is positive, and R=1 when g=0 (no noise reduction when gain is 0). So the scalar gain, g, can be approximated as:

g=(1−1/R)/a, (Eq. 22)

where a may be a known scalar value at the specific frequency.

Equation 22 is an approximation of the scalar gain factor, g, based on a magnitude relationship of |E| and |X|, e.g., |E(e)/X(e)|, at a specific frequency.

The simplified method of estimating the Sₚₐₜₕ transfer function can consistently adapt an FB ANC system under varying Sₚₐₜₕ gain. For example, noise reduction at a low audio frequency, e.g., 100 Hz, can be kept constant under varying conditions. This may be accomplished by compensating and nullifying the Sₚₐₜₕ gain g by applying a 1/g gain as part of ANC control filter C(z). That is, C=h×C₀, where h=1/g and C₀ is a predefined control filter transfer function. By doing this, the noise reduction ratio at a specified low frequency (100 Hz) can be kept constant over varying Sₚₐₜₕ gain.

Additionally, using by using the simplified estimation method, instability of an FB ANC system may be prevented or reduced under varying Sₚₐₜₕ gain. Acoustic instabilities can occur when Sₚₐₜₕ gain gets increased above some amount. To avoid instability, the ANC system can set a Sₚₐₜₕ gain threshold such that an FB ANC system is turned off or the FB control filter gain is automatically lowered when the Sₚₐₜₕ gain exceeds the threshold. This may prevent or significantly reduce the likelihood of FB ANC instability.

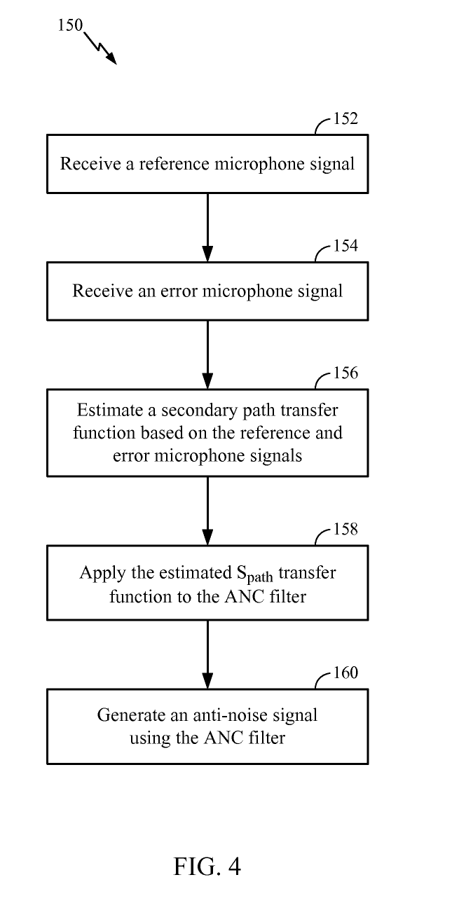

FIG. 4 is a flowchart 150 illustrating an exemplary method operating the ANC system 12 of FIG. 1. In box 152, a reference microphone signal, X′(z) is received by the system 12. In box 154, an error microphone signal, E(z), is received by the system 12. The microphone signals are provided to the secondary path estimator 18. In response to these signals, the secondary path estimator 18 estimates the secondary path transfer function, S(z), online (box 156). The secondary path estimator 18 may use either of the methods, respectively, discussed above in connection with FIGS. 2 and 3 to model the Sₚₐₜₕ transfer function.

In box 158, the estimated Sₚₐₜₕ transfer function is applied to adapt the ANC filter 14. In box 160, the adaptive ANC filter 14 generates and outputs an anti-noise signal based, in part, on the estimated Sₚₐₜₕ transfer function. The anti-noise signal is passed to the loudspeaker 16, which in turn outputs an anti-noise acoustic signal into the quiet zone 24 in response to the anti-noise signal from the adaptive ANC filter 14.

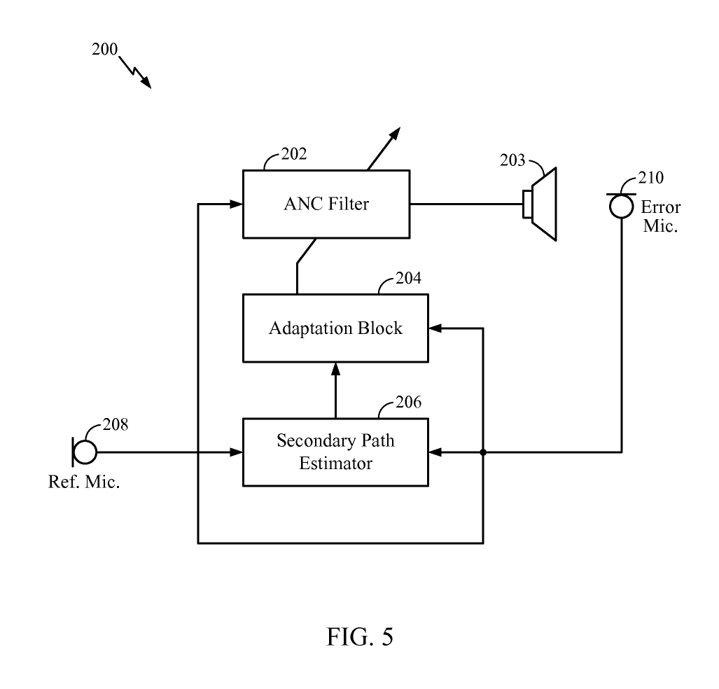

FIG. 5 is a conceptual block diagram illustrating certain components of an example feedback ANC system 200 that estimates a secondary path transfer function based on error microphone and reference microphone signals. The system 200 includes an adaptive ANC filter 202, an adaptation block 204, a secondary path estimator 206, a noise reference microphone 208, an error microphone 210 and a loudspeaker 203.

In the feedback (FB) configuration, the error microphone signal is provided as input to the ANC filter 202, the adaptation block 204, and secondary path estimator 206. The system output sensed by the error microphone is fed back to the adaptive ANC filter 202 and the filter 202 is adjusted through an adaptive algorithm (e.g., by adaption block 204) to minimize total system output power.

The reference and error microphones 208, 210 and loudspeaker 203 may each perform the microphone and loudspeaker functions, respectively, as described in connection with FIGS. 1-4. Additionally, the secondary path estimator 206 may perform the Sₚₐₜₕ modeling as described in above connection with the same figures.

The adaptation block 204 may modify or adapt the functioning of the adaptive ANC filter 202. For example, the adaptation block 204 may change the frequency response, taps or coefficients of the adaptive filter 202 based on the error microphone signal and/or output from the secondary path estimator 206. For instance, the adaptation block 204 may provide information or a signal to the adaptive filter 202 such as taps, filter coefficients and/or scaling factors.

FIG. 6 is a conceptual block diagram illustrating certain components of an example hybrid ANC system 250 that estimates the secondary path transfer function based on error microphone and reference microphone signals. The system 250 includes an adaptive ANC filter 252, an adaptation block 254, a secondary path estimator 256, a noise reference microphone 208, an error microphone 210 and a loudspeaker 203.

In the hybrid ANC configuration, both feedback and feed-forward filtering are used. Thus, the error microphone signal and noise reference microphone signals may both be provided as input to the ANC filter 252, the adaptation block 254, and secondary path estimator 256. The adaptive ANC filter 252 may include any suitable topology for the feedback and feed-forward stages of the noise control process of the hybrid ANC system 250. For example, the ANC filter 252 may include an adaptive feed-forward ANC filter, receiving the reference microphone signal, for the feed-forward stage of the hybrid ANC system 250; and the ANC filter 252 may also include an adaptive feedback ANC filter, receiving the error microphone signal, for the feedback stage of the ANC system 250. The outputs of the feed-forward and feedback stage filters may then be combined (typically summed) to produce the ANC filter 252 output.

The reference and error microphones 208, 210 and loudspeaker 203 may each perform the microphone and loudspeaker functions, respectively, as described in connection with FIGS. 1-4. Additionally, the secondary path estimator 256 may perform the Sₚₐₜₕ modeling as described in above connection with the same figures.

The adaptation block 254 may modify or adapt the functioning of the adaptive ANC filter 252. This may involve modifying or adapting the functioning of the feedback stage filter and/or the feed-forward stage filter. For example, the adaptation block 254 may change the frequency response, taps or coefficients of the feedback stage adaptive filter based on the error microphone signal and/or output from the secondary path estimator 256. Likewise, the adaptation block 254 may change the frequency response, taps or coefficients of the feed-forward stage adaptive filter based on the reference microphone signal, the error microphone signal, and/or output from the secondary path estimator 256. The adaptation block 254 may, in turn, provide information or one or more signals to the adaptive filter 252 such as taps, filter coefficients and/or scaling factors to adjust or modify the feed-forward and feedback stage filters included in the adaptive filter 252.

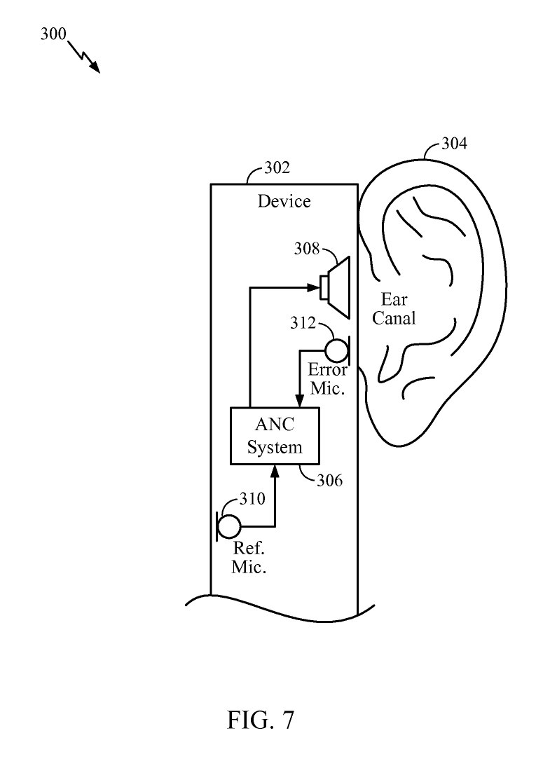

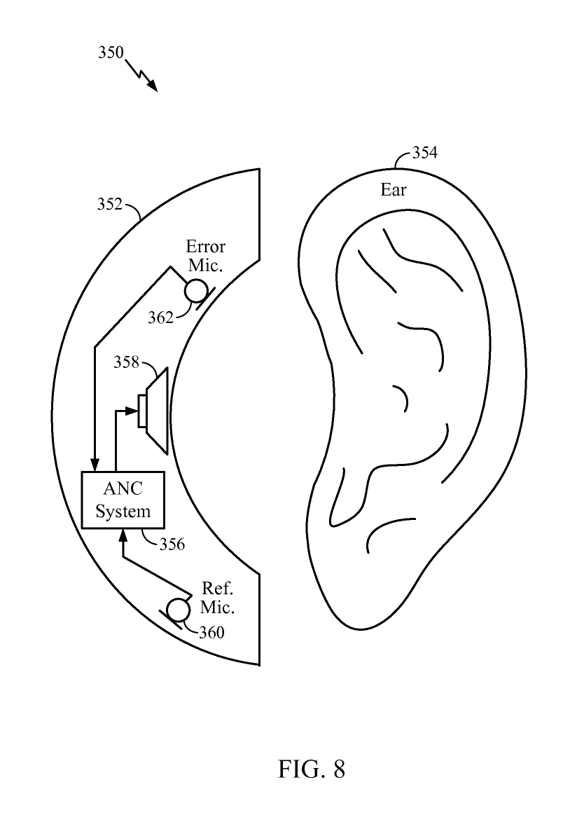

FIGS. 7 to 10 show examples of devices within which any of the various ANC structures and arrangements described above may be implemented. For example, FIG. 7 is a conceptual cross-sectional block diagram showing an exemplary portable communication device 302 that includes an ANC system 306 such as one of those described herein. In the acoustic environment 300 shown, the device 302 is placed near or against a listener's ear 304 during use. The device 302 may be a wired or wireless communication device, as described herein. In addition to incorporating the ANC system 306, the device 302 also includes: a reference microphone 310 for receiving ambient noise; an error microphone 312 located within a desired quiet zone, in this case a user's ear canal, for generating an error microphone signal; and a loudspeaker 308 for outputting an anti-noise signal produced by the ANC system 306.

FIG. 8 is a conceptual cross-sectional block diagram showing an exemplary headphone 352 that includes an ANC system 356 such as one of those described herein. In the acoustic environment 350 shown, the headphone 352 is placed near or against a listener's ear 354 during use. The headphone includes an earcup for placing against a user's ear. Incorporated into the headphone is the ANC system 356; a reference microphone 360 for receiving ambient noise; an error microphone 362 located within a desired quiet zone, in this case the space contained by the earcup, for generating an error microphone signal; and a loudspeaker 358 for outputting an anti-noise signal produced by the ANC system 356.

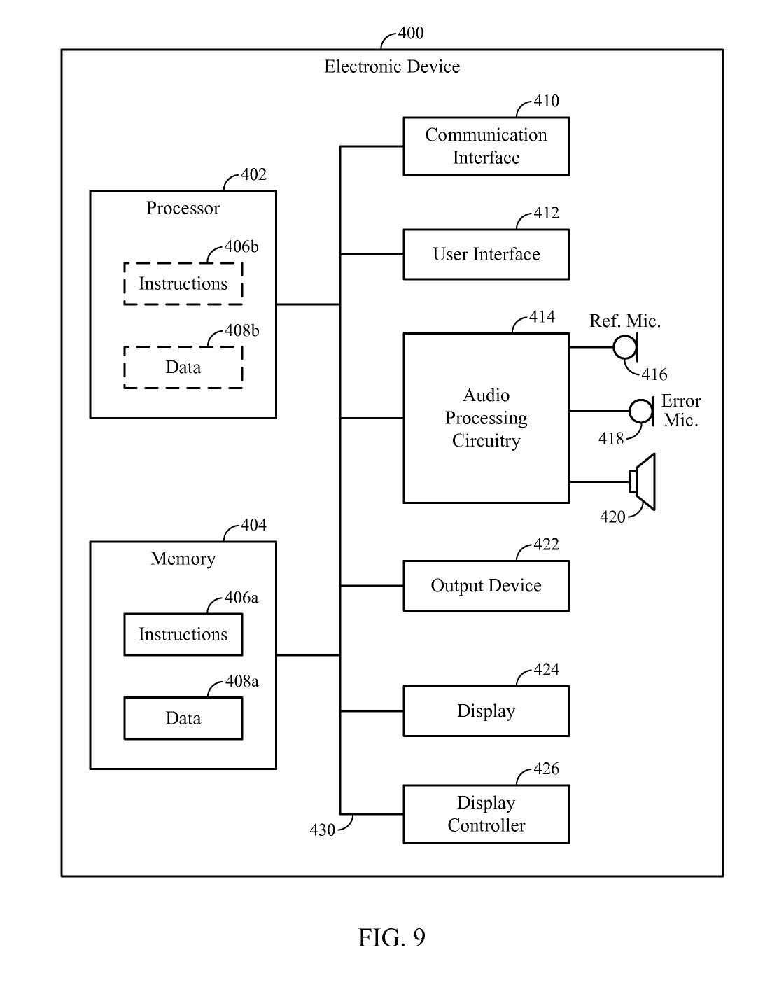

FIG. 9 is a conceptual block diagram illustrating certain components of an example electronic device 400 that may implement one or more of the ANC systems and/or secondary path estimation techniques disclosed herein. The illustrated components may be located within the same physical structure or in separate housings or structures. The electronic device 400 includes a processor 402. The processor 402 may be a general purpose single- or multi-chip microprocessor (e.g., an ARM), a special purpose microprocessor (e.g., a digital signal processor (DSP)), a microcontroller, a programmable gate array, or the like. The processor 402 may also be referred to as a central processing unit (CPU). Although just a single processor 402 is shown in the electronic device 400, in an alternative configuration, a combination of multiple processors (e.g., an ARM and DSP) could be used.

The electronic device 40 also includes memory 404 in electronic communication with the processor 402 by way of a digital bus 430. That is, the processor 402 can read information from and/or write information to the memory 404. The memory 404 may be any electronic component capable of storing electronic information. For example, the memory 404 may be random access memory (RAM), read-only memory (ROM), magnetic disk storage media, optical storage media, flash memory devices in RAM, on-board memory included with the processor 402, programmable read-only memory (PROM), erasable programmable read-only memory (EPROM), electrically erasable PROM (EEPROM), registers, and so forth, including combinations thereof.

Executable programming instructions 406a and data 408a may be stored in the memory 404. The instructions 406a may include one or more programs, routines, sub-routines, functions, procedures, and the like. The instructions 406a are executable by the processor 402 to implement one or more of the adaptive ANC and/or secondary path estimation methods described above. Executing the instructions 406a may involve the use of the data 408a that is stored in the memory 404. FIG. 9 shows some instructions 406b and data 408b being loaded into the processor 402 (which may originate from instructions 406a and data 408a).

The electronic device 400 may also include one or more communication interfaces 410 for communicating with other electronic devices. The communication interface 410 may be based on wired communication technology, wireless communication technology, or both. Examples of different types of communication interfaces 410 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and the like.

The electronic device 400 may also include one or more user-interface devices 412 and one or more output devices 422. Examples of different kinds of interface devices 412 include a keyboard, mouse, microphone, remote control device, button, joystick, trackball, touchpad, light pen, and the like. For instance, the electronic device 400 may include one or more microphones (e.g., microphones 416, 418) for capturing acoustic signals. Examples of different kinds of output devices 422 include a speaker, printer, and the like. For instance, the electronic device 400 may include one or more speakers 420.

One specific type of output device which may be included in an electronic device 400 is a display device 424. Display devices 424 used with configurations disclosed herein may utilize any suitable image projection technology, such as a cathode ray tube (CRT), liquid crystal display (LCD), light-emitting diode (LED), gas plasma, electroluminescence, or the like. A display controller 426 may also be provided, for converting data 408a stored in the memory 404 into text, graphics, and/or moving images (as appropriate) shown on the display device 424.

The device 400 may also include audio processing circuitry 414 for processing input and output audio signals. The audio processing circuitry 414 may include any suitable combination of digital processing circuits (including software) and analog hardware circuits for processing analog signals received from various microphones, include a reference microphone 416 and error microphone 418 used by an ANC system, and for outputting analog signals to loudspeakers, such as an anti-noise loudspeaker 420. The circuitry 414 may include one of more filters, amplifiers, A/D converters, D/A converters, and the like.

The various components of the electronic device 400 may be coupled together by one or more buses, which may include a power bus, a control signal bus, a status signal bus, a data bus, etc. For simplicity, the various buses are illustrated in FIG. 9 as a bus system 430. It should be noted that FIG. 9 illustrates only one possible configuration of an electronic device 400. Various other architectures and components may be utilized.

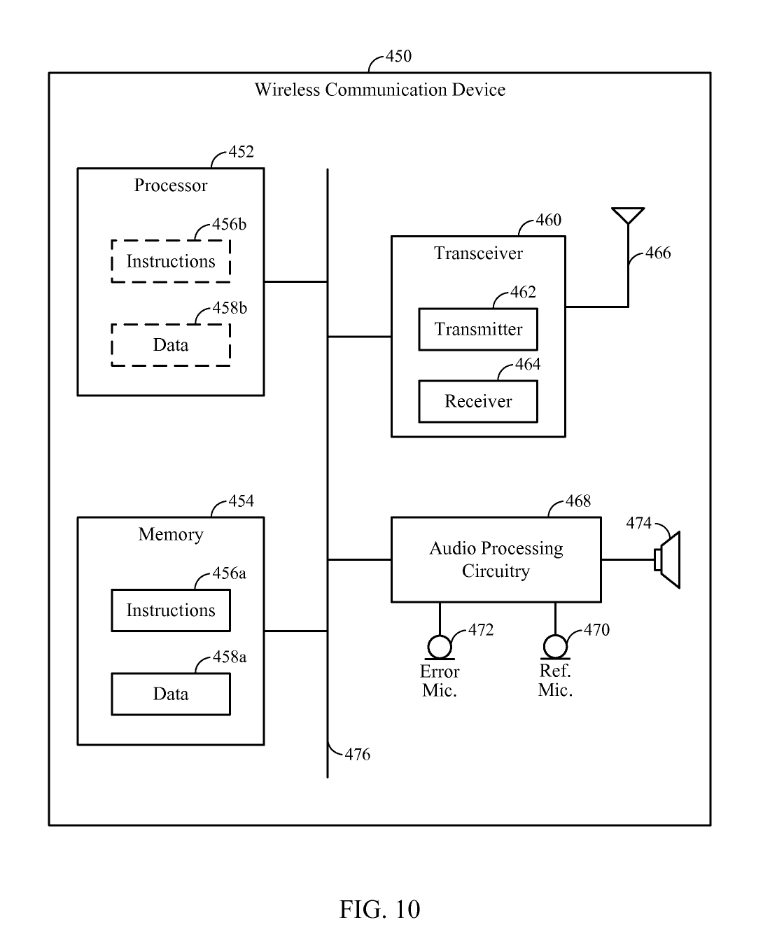

FIG. 10 is a conceptual block diagram illustrating certain components of a wireless communication device 450 that may implement one or more of the ANC systems and/or secondary path estimation techniques disclosed herein. The wireless communication device 450 includes a processor 452. The processor 452 may be a general purpose single- or multi-chip microprocessor (e.g., an ARM), a special purpose microprocessor (e.g., a DSP), a microcontroller, a programmable gate array, or the like. The processor 452 may be referred to as a CPU. Although just a single processor 452 is shown in the wireless communication device 450 of FIG. 10, in an alternative configuration, a combination of multiple processors (e.g., an ARM and DSP) could be used.

The wireless communication device 450 also includes memory 454 in electronic communication with the processor 452 by way of a bus 476 (e.g., the processor 452 can read information from and/or write information to the memory 454). The memory 454 may be any electronic component capable of storing electronic information. The memory 454 may be random access memory (RAM), read-only memory (ROM), magnetic disk storage media, optical storage media, flash memory devices in RAM, on-board memory included with the processor 452, programmable read-only memory (PROM), erasable programmable read-only memory (EPROM), electrically erasable PROM (EEPROM), registers, and so forth, including combinations thereof.

Instructions 456a and data 458a may be stored in the memory 454. The instructions 456a may include one or more programs, routines, sub-routines, functions, procedures, code, or the like. The instructions 456a are executable by the processor 452 to implement one or more of the ANC and/or secondary path estimation methods described above. Executing the instructions 456a may involve the use of the data 458a that is stored in the memory 454. FIG. 10 shows some instructions 456b and data 458b being loaded into the processor 452 (which may come from instructions 456a and data 458a in memory 454).

The wireless communication device 450 may also include a transceiver 460 having a transmitter 462 and a receiver 464 to allow transmission and reception, respectively, of signals between the wireless communication device 450 and a remote location (e.g., another electronic device, wireless communication device, or the like). An antenna 466 may be electrically coupled to the transceiver 460. The wireless communication device 450 may also include (not shown) multiple transmitters, receivers, transceivers, and/or antennas. The transceiver 460 and antenna 466 may implement one or more of the wireless communications protocols and/or standards disclosed herein.

In some configurations, the wireless communication device 450 may include one or more microphones, e.g., error microphone 472 and noise reference microphone 470, for capturing acoustic signals. Additionally, the wireless communication device 450 may include one or more speakers, e.g., anti-noise speaker 474.

The wireless communication device 450 may also include audio processing circuitry 468 for processing input and output audio signals. The audio processing circuitry 468 may include any suitable combination of digital processing circuits (including software) and analog hardware circuits for processing analog signals received from various microphones, include a reference microphone 470 and error microphone 472 used by an ANC system, and for outputting analog signals to loudspeakers, such as the anti-noise loudspeaker 474. The circuitry 468 may include one of more filters, amplifiers, A/D converters, D/A converters, and the like.

The various components of the wireless communication device 450 may be coupled together by one or more buses, which may include a power bus, a control signal bus, a status signal bus, a data bus, and the like. For simplicity, the various buses are illustrated in FIG. 10 as a bus system 476.

It should be noted that FIG. 10 illustrates only one possible configuration of a wireless communication device 450. Various other architectures and components may be utilized.

It should be understood that, depending on the example, certain acts or events of any of the methods described herein can be performed in a different sequence, may be added, merged. Moreover, in certain examples, acts or events may be performed concurrently, e.g., through multi-threaded processing, interrupt processing, or multiple processors, rather than sequentially. In addition, while certain aspects of this disclosure are described as being performed by a single module, component, block or unit for purposes of clarity, it should be understood that the techniques of this disclosure may be performed by any suitable combination of components, units, blocks or modules associated with active noise cancellation.

The functionality of the systems, devices, and their respective components, as well as the method steps and blocks described herein may be implemented in hardware, software or firmware executed by a processor, or any suitable combination thereof. The software/firmware may be one or more programs having sets of instructions (e.g., code segments) executable by one or more digital circuits or processors, such as microprocessors, digital signal processors (DSPs), embedded controllers, or intellectual property (IP) cores. If implemented in software/firmware, the instructions or code may be stored on one or more computer-readable media, such as a solid-state memory. Computer-readable medium includes any suitable computer storage medium. A storage medium may be any available medium that can be accessed by a computer. By way of example, and not limitation, such computer-readable medium can comprise RAM, ROM, EEPROM, NAND/NOR Flash, CD-ROM, or other solid-state storage, optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable medium.

As described above, programming instructions may be executed by one or more processors, such as one or more DSPs, general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for ANC. Also, the techniques could be fully implemented in one or more hardware circuits, including logic circuits and/or logic elements.

The techniques of this disclosure may be implemented in a wide variety of devices or apparatuses, including a wireless handset, headphones, a personal computer, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of inter-operative hardware units, including one or more processors as described above, in conjunction with suitable software and/or firmware.

Other embodiments and modifications of the methods, devices, systems and apparatuses described above will occur readily to those of ordinary skill in the art in view of these teachings. Thus, the foregoing description is illustrative and not restrictive. The following claims cover all such other embodiments and modifications, particularly when viewed in conjunction with the above specification and accompanying drawings. The scope of the claims should, therefore, not be limited to the above description, but instead should be determined with reference primarily to the appended claims along with their full scope of equivalents.

What is claimed is:

1. A method, comprising:
receiving a first environmental signal at an active noise cancellation (ANC) system;
receiving a second environmental signal at the ANC system; and
the ANC system estimating a secondary path transfer function based on the first environmental signal and the second environmental signal.

2. The method of claim 1, wherein the ANC system estimates the secondary path transfer function without using a pilot signal.

3. The method of claim 1, wherein the first environmental signal is a reference microphone signal and the second environmental signal is an error microphone signal.

4. The method of claim 1, wherein estimating the secondary path transfer function includes:
estimating a first transfer function between the first environmental signal and the second environmental signal; and
estimating the secondary path transfer function based on the first transfer function.

5. The method of claim 4, wherein estimating the secondary path transfer function includes:
estimating the secondary path transfer function based on both a control transfer function and the first transfer function.

6. The method of claim 5, wherein estimating the first transfer function includes performing an adaptive identification method.

7. The method of claim 6, wherein the adaptive identification method is selected from the group consisting of a least mean square (LMS) method, recursive least square (RLS) method, a Wiener filter, and any suitable combination of the foregoing.

8. The method of claim 1, wherein the secondary path transfer function is estimated online.

9. The method of claim 1, further comprising:
measuring offline a baseline secondary path transfer function;
wherein estimating the secondary path transfer function includes multiplying the baseline secondary path transfer function by a scalar gain factor to obtain an estimate of the secondary path transfer function, wherein the scalar gain factor is based on the magnitude of the first environmental signal and the magnitude of the second environmental signal.

10. The method of claim 1, further comprising:
generating a noise cancellation signal based, at least in part, on the secondary path transfer function.

11. An active noise cancellation (ANC) system, comprising:
a first input configured to receive a first environmental signal;
a second input configured to receive a second environmental signal; and
a processor configured to estimate a secondary path transfer function based on the first environmental signal and the second environmental signal.

12. The system of claim 11, further comprising a reference microphone configured to receive the first environmental signal and an error microphone configured to receive the second environmental signal.

13. The system of claim 11, wherein the processor is further configured to:
estimate a first transfer function between the first environmental signal and the second environmental signal; and
estimate the secondary path transfer function based on the first transfer function.

14. The system of claim 13, wherein the processor is further configured to:
estimate the secondary path transfer function based on both a control transfer function and the first transfer function.

15. The system of claim 13, wherein the processor performs an adaptive identification method to estimate the first transfer function.

16. The system of claim 15, wherein the adaptive identification method is selected from the group consisting of a least mean square (LMS) method, recursive least square (RLS) method, a Wiener filter, and any suitable combination of the foregoing.

17. The system of claim 11, wherein the processor estimates the secondary path transfer function online.

18. The system of claim 11, wherein the processor is configured to:
measure a baseline secondary path transfer function offline; and
multiply the baseline secondary path transfer function by a scalar gain factor to obtain an estimate of the secondary path transfer function, wherein the scalar gain factor is based on the magnitude of the first environmental signal and the magnitude of the second environmental signal.

19. The system of claim 11, wherein the ANC system is configured to generate a noise cancellation signal based, at least in part, on the secondary path transfer function.

20. The system of claim 11, wherein the ANC system is selected from the group consisting of a feedback ANC system, a feed-forward ANC system and a hybrid ANC system.

21. The system of claim 11, wherein the ANC system is included in a device selected from the group consisting of a headset, a headphone, an earphone, a handset, and any suitable combination of the foregoing.

22. A system, comprising:
means for receiving a first environmental signal;
means for receiving a second environmental signal; and
means for estimating a secondary path transfer function of an active noise cancellation (ANC) system based on the first environmental signal and the second environmental signal.

23. The system of claim 22, wherein the first environmental signal is a reference microphone signal and the second environmental signal is an error microphone signal.

24. The system of claim 22, wherein the means for estimating the secondary path transfer function includes:
means for estimating a first transfer function between the first environmental signal and the second environmental signal; and
means for estimating the secondary path transfer function based on the first transfer function.

25. The system of claim 24, wherein the means for estimating the secondary path transfer function includes:
means for estimating the secondary path transfer function based on both a control transfer function and the first transfer function.

26. The system of claim 22, further comprising:
means for measuring offline a baseline secondary path transfer function; and
means for multiplying the baseline secondary path transfer function by a scalar gain factor to obtain an estimate of the secondary path transfer function, wherein the scalar gain factor is based on the magnitude of the first environmental signal and the magnitude of the second environmental signal.

27. A non-transient computer-readable medium embodying a set of instructions executable by one or more processors, comprising:
code for receiving a first environmental signal;
code for receiving a second environmental signal; and
code for estimating a secondary path transfer function of an active noise cancellation (ANC) system based on the first environmental signal and the second environmental signal.

28. The computer-readable medium of claim 27, wherein the code for estimating the secondary path transfer function includes:
code for estimating a first transfer function between the first environmental signal and the second environmental signal; and
code for estimating the secondary path transfer function based on the first transfer function.

29. The computer-readable medium of claim 28, wherein the code for estimating the secondary path transfer function includes:
code for estimating the secondary path transfer function based on both a control transfer function and the first transfer function.

30. The computer-readable medium of claim 29, further comprising:
code for measuring offline a baseline secondary path transfer function; and
code for multiplying the baseline secondary path transfer function by a scalar gain factor to obtain an estimate of the secondary path transfer function, wherein the scalar gain factor is based on the magnitude of the first environmental signal and the magnitude of the second environmental signal.
